(19) United States
(12) Patent Application Publication
(10) Pub. No.: US 2026/0237219 A1
(43) Pub. Date: Aug. 13, 2026

(54) PROCESSING DEVICE FOR TRAFFIC STATUS MONITORING SYSTEM

(71) Applicant: NEC Corporation, Tokyo (JP)

(72) Inventor: Akira TADA, Tokyo (JP)

(73) Assignee: NEC Corporation, Tokyo (JP)

(21) Appl. No.: 19/156,548

(22) PCT Filed: Feb. 22, 2023
(86) PCT No.: PCT/JP2023/006478

§ 371 Date: Aug. 14, 2025

(51) Int. Cl. G06V 20/54; G06V 20/40; G06V 20/62

(52) U.S. Cl. CPC G06V 20/54; G06V 20/44; G06V 20/625

(57) ABSTRACT

This processing device includes a first acquisition unit, a second acquisition unit and an image processing unit. The first acquisition unit acquires a first image which contains a pedestrian crossing and/or intersection and which has been captured by a first camera for capturing the first image, the first camera belonging to a first traffic signal including a first communication device and the first camera. The second acquisition unit acquires a second image which contains the pedestrian crossing and/or intersection and which has been transmitted by a second communication device for transmitting the second image to the first communication device, the second communication device belonging to a second traffic signal including the second communication device and a second camera for capturing the second image. The image processing unit detects a traffic accident at the pedestrian crossing and/or intersection based on the first image and the second image.

### TECHNICAL FIELD

The present disclosure relates to a processing device, a traffic status monitoring system, a processing method, and a program.

### BACKGROUND ART

It is known that a traffic abnormality different from a normal traffic status, such as a traffic accident and a traffic violation, is detected on a road.

For example, PTL 1 discloses a technique of using a road image in which a road condition is picked up, in order to detect occurrence of a traffic accident.

### CITATION LIST

### Patent Literature

PTL 1: JP 2018-173688 A

### SUMMARY OF INVENTION

### Technical Problem

In PTL 1, a detector detects a traffic accident mainly from a road image taken by an imaging device incorporated in a roadside unit. However, it is difficult to detect a traffic abnormality in a blind spot of the roadside unit.

An object of the present disclosure is to provide a processing device, a traffic status monitoring system, a processing method, and a program that solve the problem described above.

### Solution to Problem

A processing device according to one aspect of the present disclosure includes first acquisition means for acquiring a first image picked up by a first camera of a first traffic light, the first traffic light having the first camera that picks up the first image containing at least one of a crosswalk and an intersection, and a first communication device, second acquisition means for acquiring a second image transmitted by a second communication device of a second traffic light, the second traffic light having a second camera that picks up the second image containing at least one of the crosswalk and the intersection, and the second communication device that transmits the second image to the first communication device, and image processing means for detecting, based on the first image and the second image, a traffic abnormality occurring in at least one of the crosswalk and the intersection.

A processing method according to one aspect of the present disclosure includes a step of acquiring a first image picked up by a first camera of a first traffic light, the first traffic light including the first camera that picks up the first image containing at least one of a crosswalk and an intersection, and a first communication device, a step of acquiring a second image transmitted by a second communication device of a second traffic light, the second traffic light including a second camera that picks up the second image containing at least one of the crosswalk and the intersection, and the second communication device that transmits the second image to the first communication device, and a step of detecting, based on the first image and the second image, a traffic abnormality occurring in at least one of the crosswalk and the intersection.

A program according to one aspect of the present disclosure is a program that causes a computer to execute a step of acquiring a first image picked up by a first camera of a first traffic light, the first traffic light including the first camera that picks up the first image containing at least one of a crosswalk and an intersection, and a first communication device, a step of acquiring a second image transmitted by a second communication device of a second traffic light, the second traffic light including a second camera that picks up the second image containing at least one of the crosswalk and the intersection, and the second communication device that transmits the second image to the first communication device, and a step of detecting, based on the first image and the second image, a traffic abnormality occurring in at least one of the crosswalk and the intersection.

### Advantageous Effects of Invention

According to the processing device, the traffic status monitoring system, the processing method, and the program of the present disclosure, traffic abnormalities are easily detected.

### BRIEF DESCRIPTION OF DRAWINGS

FIG. 1 is a diagram illustrating an overview of a traffic status monitoring system in a first example embodiment.

FIG. 2 is a diagram illustrating transmission and reception of data in the first example embodiment.

FIG. 3 is a block diagram illustrating a configuration of an in-vehicle device in the first example embodiment.

FIG. 4 is a block diagram illustrating a configuration of a processing device in the first example embodiment.

FIG. 5 is a flowchart illustrating an operation of cameras attached to traffic lights in the first example embodiment.

FIG. 6 is a flowchart illustrating an operation of the in-vehicle device in the first example embodiment.

FIG. 7 is a flowchart illustrating an operation of the processing device in the first example embodiment.

FIG. 8 is a diagram illustrating an overview of a traffic status monitoring system in a second example embodiment.

FIG. 9 is a block diagram illustrating a configuration of a processing device in the second example embodiment.

FIG. 10 is a flowchart illustrating an operation of the processing device in the second example embodiment.

FIG. 11 is a block diagram illustrating a configuration of a processing device according to a third example embodiment.

FIG. 12 is a flowchart illustrating an operation of a processing device in a fourth example embodiment.

### EXAMPLE EMBODIMENT

Hereinafter, example embodiments according to the present disclosure will be described with reference to the drawings. The drawings and specific configurations used in the example embodiments should not be used for interpretation of the disclosure. In all the drawings, the same or corresponding components are denoted by the same reference signs, and the common description will be omitted.

### First Example Embodiment

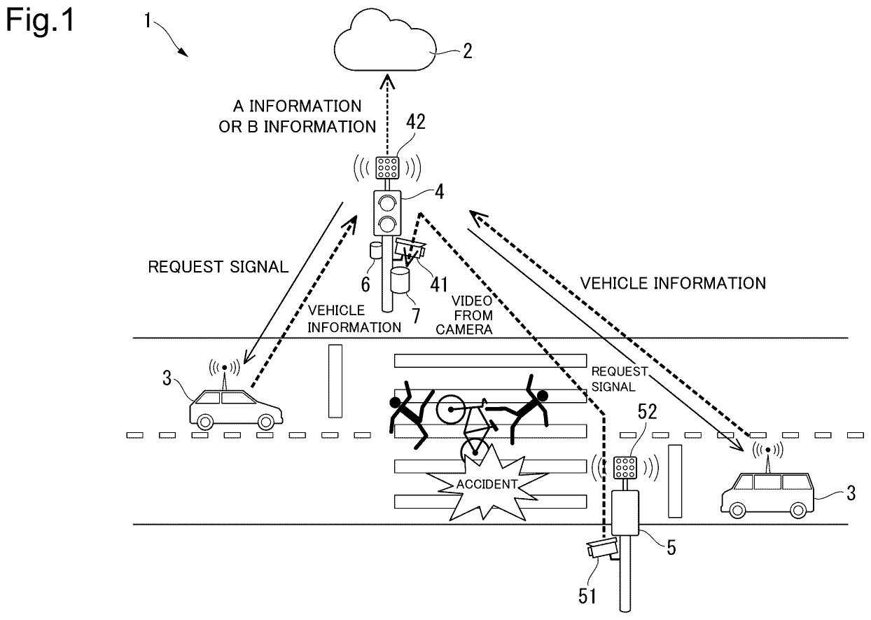

Hereinafter, a first example embodiment according to the present disclosure will be described with reference to FIGS. 1 to 7.

### (Configuration of Traffic Status Monitoring System)

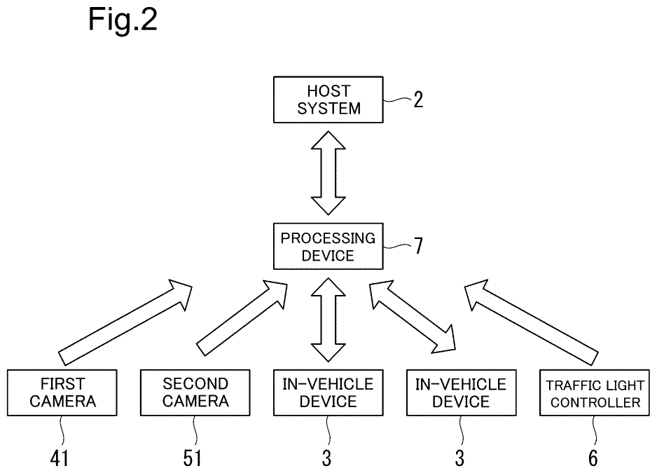

As illustrated in FIGS. 1 and 2, a traffic status monitoring system 1 includes a host system 2, in-vehicle devices 3, a first traffic light 4, a second traffic light 5, a traffic light controller 6, and a processing device 7.

As illustrated in FIG. 2, the host system 2 transmits and receives data and request signals to and from the processing device 7.

The processing device 7 receives, in the traffic status monitoring system 1, information on a traffic abnormality different from a normal traffic status, such as a traffic accident and a traffic violation, from the in-vehicle devices 3, the first traffic light 4, the second traffic light 5, and the traffic light controller 6. In addition, the processing device 7 transmits and receives data and signals to and from the in-vehicle devices 3 in a step to be described later.

In the present example embodiment, the processing device 7 is attached to the first traffic light 4.

The traffic light controller 6 controls flashing of the first traffic light 4 based on traffic-light lighting information as well as outputting lighting information. The processing device 7 to be described later mainly acquires the lighting information of the traffic lights from a first image and a second image. However, when the lighting information cannot be obtained from the first image and the second image due to inclement weather, blockage by a large vehicle, or the like, the processing device 7 acquires the lighting information output from the traffic light controller 6.

In the present example embodiment, the traffic light controller 6 is attached to the first traffic light 4.

A method for communication among components in the traffic status monitoring system 1 may be either wired or wireless.

### (Configuration of Traffic Light)

As illustrated in FIG. 1, the first traffic light 4 includes a first camera 41 that picks up the first image containing at least one of a crosswalk and an intersection, and a first communication device 42.

The second traffic light 5 includes a second camera 51 that picks up the second image containing at least one of the crosswalk and the intersection, and a second communication device 52.

The first traffic light 4 and the second traffic light 5 are arranged in such a way that the first image picked up by the first camera 41 contains the lighting information of the second traffic light 5, and the second image picked up by the second camera 51 contains the lighting information of the first traffic light 4.

As an example in the first example embodiment of the present disclosure, the first traffic light 4 and the second traffic light 5 are provided across the crosswalk from each other.

The first communication device 42 communicates with other components in the traffic status monitoring system 1 in accordance with an instruction from the processing device 7 to be described later.

The second communication device 52 transmits the second image to the first communication device 42.

### (Configuration of In-Vehicle Device)

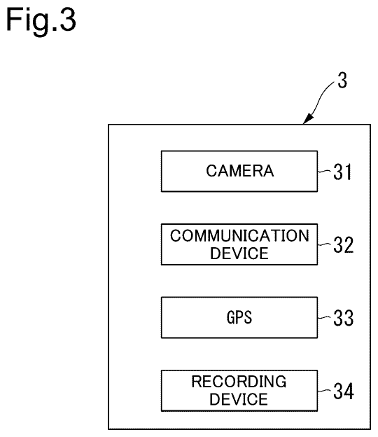

As illustrated in FIG. 3, the in-vehicle device 3 includes a camera 31, a communication device 32, a global positioning system (hereinafter, referred to as GPS) 33, and a recording device 34.

The camera 31 is a device that picks up a surrounding situation image seen from a vehicle, and is installed in the vehicle.

Image data of the surrounding situation image picked up by the camera 31 is recorded in the recording device 34.

The communication device 32 receives a request signal for information from the processing device 7, and transmits the image data of the surrounding situation image picked up by the camera 31 and vehicle information to the processing device 7 via a network.

The vehicle information contains a travel history of the vehicle, the surrounding situation image representing a vehicle surrounding situation, position information of the vehicle, a time of an internal clock of the in-vehicle device, acceleration information, and the like.

The GPS 33 measures a current position of the vehicle.

### (Configuration of Processing Device)

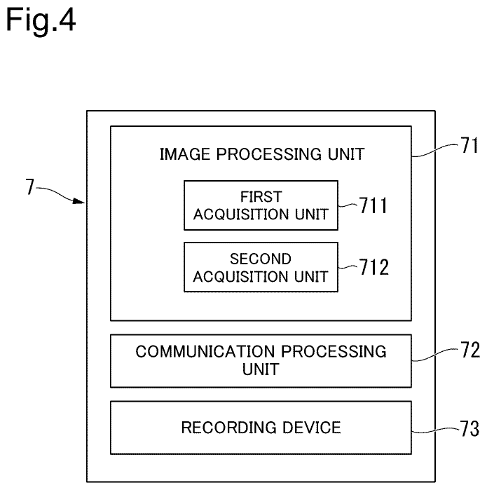

As illustrated in FIG. 4, the processing device 7 includes an image processing unit 71, a communication processing unit 72, and a recording device 73.

The image processing unit 71 includes a first acquisition unit 711 that acquires the first image picked up by the first camera 41, and a second acquisition unit 712 that acquires the second image picked up by the second camera 51.

The image processing unit 71 performs image processing on the first image acquired by the first acquisition unit 711 and the second image acquired by the second acquisition unit 712 by using a known technique of a combination of an analysis method, such as image analysis and video analysis, and machine learning, for example. The above-described image processing is performed, whereby the processing device 7 recognizes a vehicle and a person in real time. In addition, the processing device 7 also recognizes lighting conditions of the traffic lights. Thus, the image processing unit 71 detects, through the image processing, a traffic abnormality different from a normal traffic status, such as a traffic accident and a traffic violation, the traffic abnormality occurring in at least one of the crosswalk and the intersection.

As examples of the traffic abnormality, various kinds of traffic status different from a normal traffic status are cited, for example, a traffic accident, a traffic violation that can be detected through the image processing, such as an overspeed and ignoring a traffic light, or dropping from a vehicle, a state in which a vehicle cannot be move due to a vehicle abnormality, and the like. The traffic abnormality is not limited to ones related to the vehicle, and is any traffic abnormality that can be detected through the image processing performed by the processing device 7.

The communication processing unit 72 transmits and receives data and transmits request signals via the first communication device 42. The communication processing unit 72 includes a communication function of causing, in the traffic status monitoring system 1, the first communication device 42 to transmit a request signal for requesting a surrounding situation image to a surrounding vehicle with respect to the first traffic light 4 or the second traffic light 5.

In addition, the communication processing unit 72 includes a communication function of causing the first communication device 42 to transmit, to the host system 2, integrated information containing the first image, the second image, the lighting information, the vehicle information, and position information of the traffic light.

The recording device 73 stores the first image acquired by the first acquisition unit 711 and the second image acquired by the second acquisition unit 712.

### (Processing Method)

A processing method in the present example embodiment will be described.

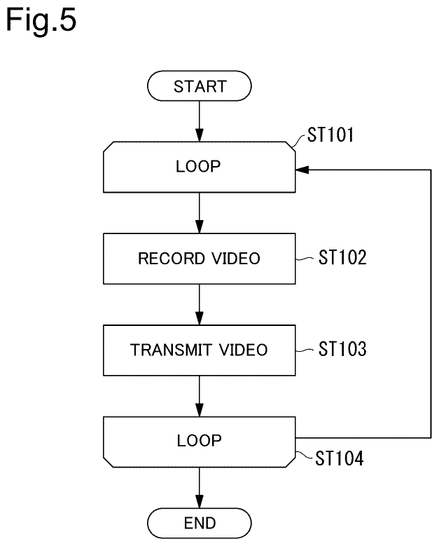

The processing method of the processing device in the present example embodiment is performed according to flows illustrated in FIGS. 5 to 7.

FIG. 5 is a flowchart illustrating operating processes of the first camera 41 and the second camera 51 according to the first example embodiment.

First, the first camera 41 and the second camera 51 execute loop processing of recording images and transmitting the images to the processing device 7 (ST101).

The first camera 41 and the second camera 51 record images in at least one of a crosswalk and an intersection (ST102).

Next, the first camera 41 and the second camera 51 transmit a first image and a second image to the processing device 7.

At this time, the second camera 51 transmits the second image via the second communication device 52 (ST103).

Then, the first camera 41 and the second camera 51 are returned to ST101 by the loop processing (ST104).

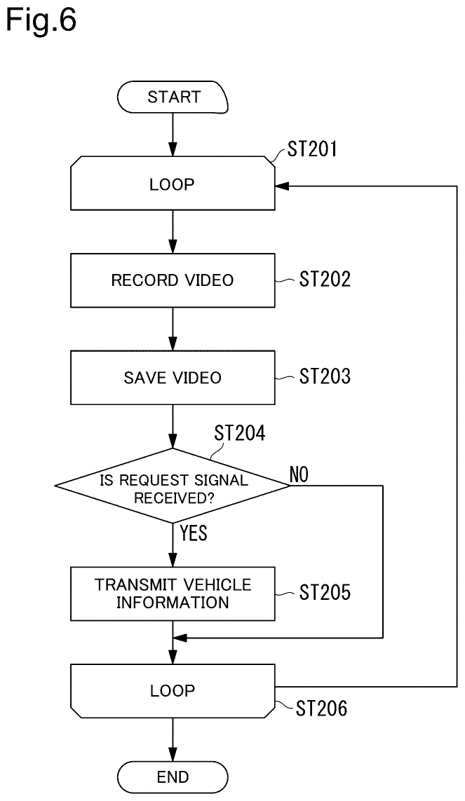

FIG. 6 is a flowchart illustrating an operating process of the in-vehicle device 3 according to the first example embodiment.

First, the in-vehicle device 3 executes loop processing of recording images, and transmitting a surrounding situation image to the processing device 7 subsequent to determination whether a request signal for vehicle information is received (ST201).

The in-vehicle device 3 records surrounding situation images of a vehicle with the camera 31 (ST202).

Next, the in-vehicle device 3 stores the surrounding situation images recorded by the camera 31 in the recording device 34 (ST203).

Then, the in-vehicle device 3 determines whether a request signal for vehicle information is received from the processing device 7 via the first communication device 42 (ST204).

When receiving the request signal from the processing device 7 (ST204: YES), the in-vehicle device 3 transmits a surrounding situation image picked up by the camera 31 and vehicle information data to the processing device 7 (ST205).

The transmitted surrounding situation image is an image after a lapse of a certain time before and/or after a time point when a traffic abnormality occurs. When not receiving the request signal from the processing device 7 (ST204: NO), the in-vehicle device 3 does not transmit the surrounding situation image picked up by the camera 31 and the vehicle information data.

Then, the in-vehicle device 3 is returned to ST201 by the loop processing (ST206).

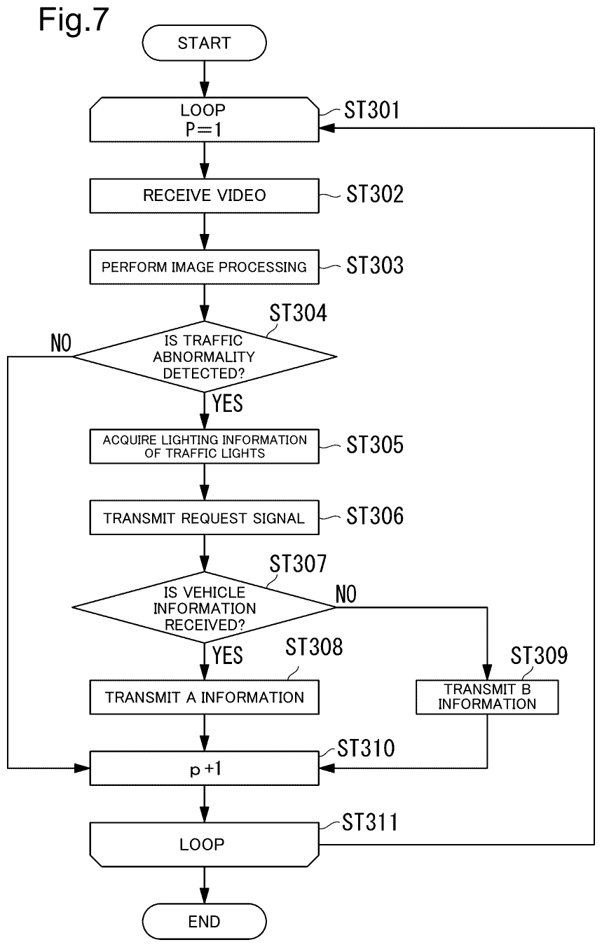

FIG. 7 is a flowchart illustrating an operating process of the processing device 7 according to the first example embodiment.

First, the processing device 7 executes loop processing of receiving first images and second images recorded by the first camera 41 and the second camera 51, detecting a traffic abnormality different from a normal traffic status, such as a traffic accident and a traffic violation, and transmitting integrated information to the host system 2 (ST301).

The processing device 7 receives a first image picked up by the first camera 41 (ST302).

The processing device 7 also receives a second image picked up by the second camera 51 via the second communication device 52 of the second traffic light 5.

Next, the processing device 7 performs image processing on the first image and the second image (ST303).

The image processing is performed for each frame using the above-described known technique.

Next, the processing device 7 performs detection determination of a traffic abnormality in at least one of a crosswalk and an intersection through the image processing (ST304).

When no traffic abnormality is detected (ST304: NO), the processing device 7 starts image processing on a p+1-th frame (ST310).

When a traffic abnormality is detected (ST304: YES), the processing device 7 acquires lighting information (ST305).

The lighting information of the traffic lights is mainly acquired from the first image and the second image. However, when the lighting information cannot be obtained from the first image and the second image as described above, the processing device 7 obtains the lighting information output from the traffic light controller 6.

The processing device 7 then transmits a request signal for vehicle information to an in-vehicle device 3 included in a surrounding vehicle with respect to the first traffic light 4 or the second traffic light 5 in which the traffic abnormality occurs (ST306).

Next, the processing device 7 determines whether the vehicle information is gained from the surrounding in-vehicle device 3 (ST307).

Time required for determining whether the vehicle information is gained is determined as whether the processing device 7 receives the vehicle information within a certain time after the request signal is transmitted.

When receiving the vehicle information (ST307: YES), the processing device 7 transmits A information to the host system (ST308).

The A information contains the vehicle information, image data of the first image and the second image picked up by the first camera 41 and the second camera 51, the lighting information, and position information of the first traffic light 4.

When not receiving the vehicle information (ST307: NO), the processing device 7 transmits B information to the host system (ST309).

The B information contains the image data of the first image and the second image picked up by the first camera 41 and the second camera 51, the lighting information, and the position information of the first traffic light 4.

Next, the processing device 7 starts image processing on a p+1-th frame (ST310).

Then, the processing device 7 is returned to ST301 by the loop processing (ST311).

### (Operation and Effect)

According to the processing device 7 of the present example embodiment, it is possible to perform the image processing on two images of the first image and the second image and detect a traffic abnormality.

The processing device 7 according to the present disclosure therefore easily detects traffic abnormalities.

According to one aspect of the present disclosure, the processing device 7 can detect a traffic abnormality different from a normal traffic status, such as a traffic accident and a traffic violation, with the image processing unit 71 and a plurality of images picked up by the cameras installed in the traffic lights.

Furthermore, the traffic status monitoring system 1 can collectively gather traffic information around a site in which a traffic abnormality occurs, by the processing device 7 transmitting and receiving data. Thus, it is possible to more accurately ascertain an occurrence situation of a traffic abnormality based on each piece of the gathered data.

In the present disclosure, a traffic abnormality is detected with images picked up by the cameras installed at the respective traffic lights, so that it is possible to acquire a situation of a vehicle without a dashboard camera mounted thereon, information on an accident between a person and a bicycle without a vehicle involved, and the like.

### Modified Example

In the example of the above example embodiment, the traffic status monitoring system 1 may not include the in-vehicle device 3.

Any of the components in the traffic status monitoring system 1 may emit a trigger signal for facilitating synchronization among a plurality of pieces of information. A sending timing of the trigger signal may be when a traffic abnormality is detected or may be after a traffic abnormality is detected.

In the example of the above example embodiment, the GPS 33 may be replaced with a global navigation satellite system (GNSS) that is a superordinate concept.

In the example of the above example embodiment, the in-vehicle device 3 may include a plurality of the cameras 31.

In the example of the above example embodiment, the camera 31 may be an omnidirectional camera of which angle of view is not limited to one direction.

In the example of the above example embodiment, the vehicle information may be some of the elements described above.

In the example of the above example embodiment, the vehicle information may be other than the elements described above.

In the example of the above example embodiment, each of the traffic lights may include two or more cameras. In this case, the lighting information of one traffic light is contained in any of images picked by the two or more cameras provided in the other traffic light.

In the example of the above example embodiment, the recording device 73 may have a function of erasing old image information depending on a remaining amount of storage capacity, and writing new image information.

### Second Example Embodiment

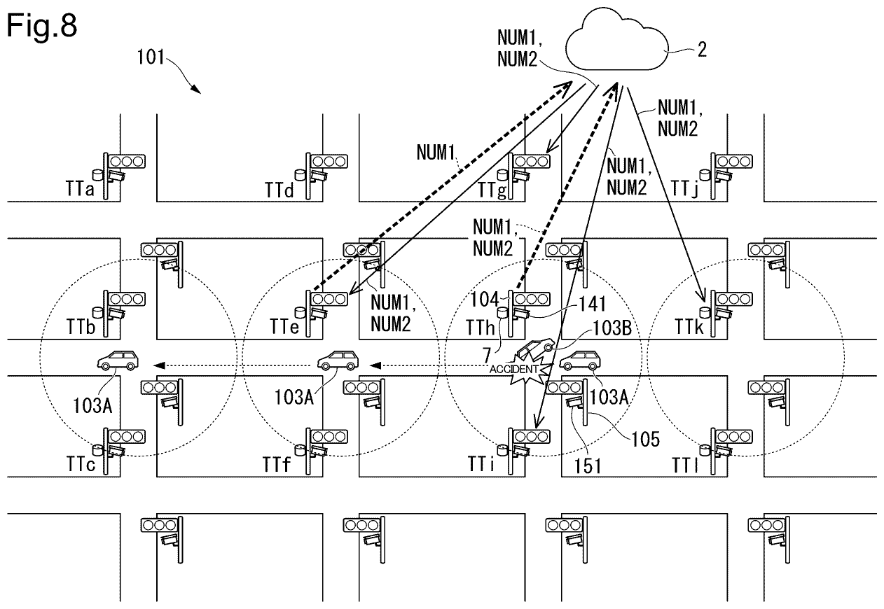

Hereinafter, a second example embodiment according to the present disclosure will be described with reference to FIGS. 8 to 10.

Components common to those of the first example embodiment are denoted by the same reference signs, and detailed description thereof will be omitted.

The first example embodiment is the traffic status monitoring system including the processing device capable of detecting a traffic abnormality by performing the image processing on the two images of the first image and the second image.

On the other hand, a processing device according to the present example embodiment includes a recognition unit that recognizes a license plate by image processing on picked up images, and a notification unit that notifies a host system of information of the license plate. A traffic status monitoring system including the processing device of the present example embodiment is effective for tracking.

### (Configuration)

As illustrated in FIG. 8, a traffic status monitoring system 101 includes a host system 2, a first traffic light 104, a second traffic light 105, and a processing device 7. In the present example embodiment, as an example, the first traffic light 104 and the second traffic light 105 are provided across an intersection from each other.

In FIG. 8, an at-fault vehicle 103A and a damaged vehicle 103B are depicted as vehicles each including an in-vehicle device 3. An intersection TTh in which both vehicles are present is an intersection in which a traffic abnormality is detected.

The first traffic light 104 includes a first camera 141, the above-described first communication device 42, and the above-described traffic light controller 6.

The second traffic light 105 includes a second camera 151 and the above-described second communication device 52.

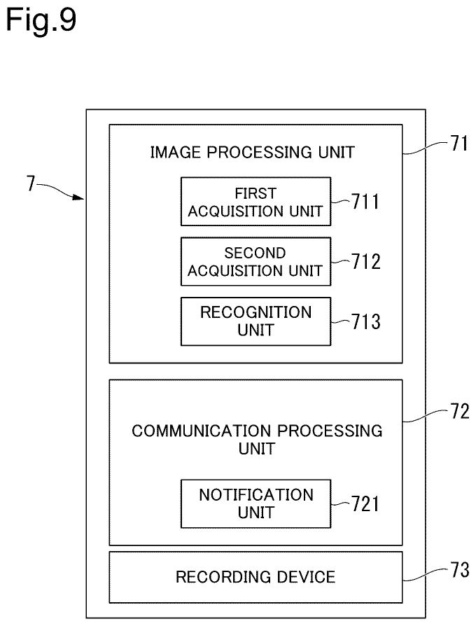

As illustrated in FIG. 9, an image processing unit 71 further includes a recognition unit 713. A communication processing unit 72 further includes a notification unit 721. Any form may be employed as long as the recognition unit 713 and the notification unit 721 are included in the traffic status monitoring system 101. In the present example embodiment, in consideration of integrated processing in the processing device 7, the processing device 7 includes the recognition unit 713 and the notification unit 721.

In the present example embodiment, the processing device 7 is attached to the first traffic light 104.

The recognition unit 713 recognizes, based on a first image and a second image picked up by the above-described first camera 141 and the second camera 151, an accident vehicle number that is a license plate of an at-fault vehicle causing a traffic accident, and a surrounding vehicle number(s), including a damaged vehicle, that is a license plate of a surrounding vehicle present around the at-fault vehicle.

The notification unit 721 notifies the accident vehicle number and the surrounding vehicle number to surrounding traffic lights adjacent to the first traffic light 104 and the second traffic light 105 via the host system 2.

As a modified example, the notification unit 721 may directly notify processing devices 7 installed in the surrounding traffic lights without an intervention of the host system 2.

Thereafter, the processing devices 7 receive the accident vehicle number and the surrounding vehicle number from the host system 2. The processing devices 7 that receive the accident vehicle number and the surrounding vehicle number are processing devices 7 present at intersections adjacent to the intersection TTh in which the traffic abnormality is detected in FIG. 8. In an example of FIG. 8, first, the accident vehicle number (NUM1) and the surrounding vehicle number (NUM2) in the intersection TTh are notified to the processing devices 7 present at an intersection TTe, an intersection TTg, an intersection TTi, and an intersection TTk that are adjacent to the intersection TTh. When the accident vehicle number (NUM1) of the at-fault vehicle 103A is detected at the intersection TTe, the processing device 7 present at the intersection TTe notifies the host system 2 that the accident vehicle number (NUM1) of the at-fault vehicle 103A is detected at the intersection TTe. Next, the host system 2 notifies the accident vehicle number (NUM1) of the at-fault vehicle 103A to processing devices 7 present at an intersection TTb, an intersection TTd, an intersection TTf, and the intersection TTh that are adjacent to the intersection TTe. Then, a nearby processing device 7 that detects the accident vehicle number (NUM1) of the at-fault vehicle 103A performs notification to the host system 2 again, and the host system 2 again performs notification of the vehicle number to processing devices 7 at intersections that are adjacent to the intersection present at the processing device 7 that issues the notification. Repeating this processing allows the traffic status monitoring system 101 to track the accident vehicle number of the at-fault vehicle and the position of the vehicle in real time.

### (Processing Method)

A processing method in the present example embodiment will be described.

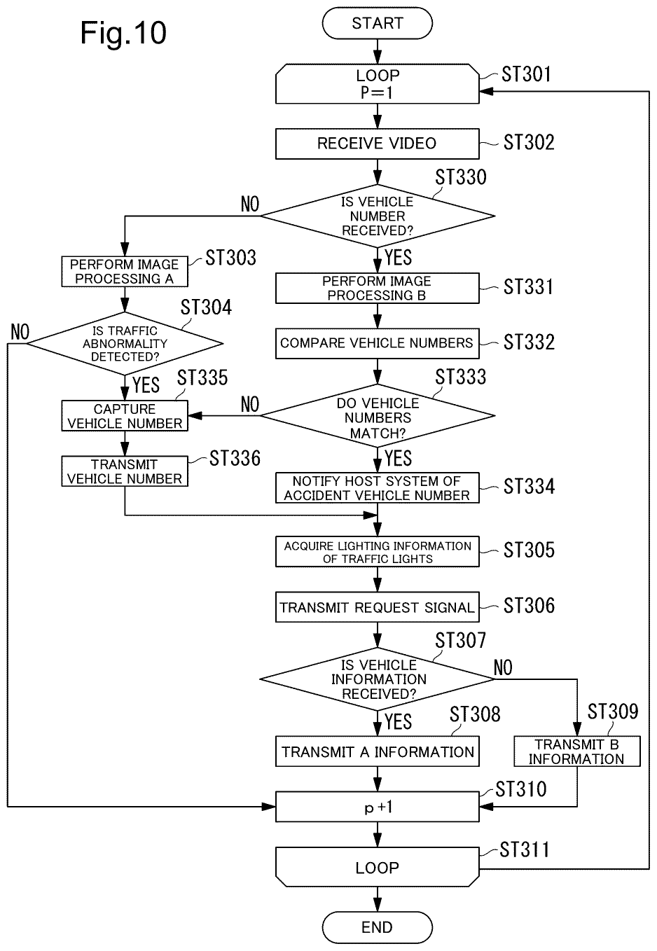

The processing method of the processing device in the present example embodiment is performed according to a flow illustrated in FIG. 10.

First, the processing device 7 executes loop processing of receiving first images and second images recorded by the first camera 141 and the second camera 151, performing different pieces of image processing when receiving an accident vehicle number of an at-fault vehicle and a surrounding vehicle number of a surrounding vehicle from the host system 2, and branching the processing to the following two pieces of processing (ST301).

The processing device 7 receives a first image and a second image picked up by the first camera 141 and the second camera 151 (ST302).

Next, the processing device 7 determines whether an accident vehicle number of an at-fault vehicle and a surrounding vehicle number of a surrounding vehicle at an intersection in which a traffic abnormality occurs are received anew from the host system 2 (ST330).

When determining that the vehicle numbers are received (ST330: YES), the processing device 7 performs image processing B (ST331).

In the image processing B, in addition to the processing of ST303 of the first example embodiment, processing is performed of recognizing a vehicle number from the first image and the second image picked up by the first camera 141 and the second camera 151.

At the time of receiving vehicle information, it is conceivable that a traffic abnormality occurs at a surrounding intersection.

Next, the processing device 7 compares the recognized vehicle number with the accident vehicle number of the at-fault vehicle received from the host system 2 (ST332).

The processing device 7 then determines whether the recognized vehicle number matches the compared accident vehicle number (ST333).

If not (ST333: NO), the processing device 7 performs processing of ST335 to be described later.

When the vehicle numbers match (ST333: YES), the processing device 7 notifies the host system 2 of the accident vehicle number (ST334).

Subsequently, the processing device 7 performs processing same as that of the first example embodiment (ST305 to ST311).

Here, A information contains vehicle information, image data of the first image and the second image picked up by the first camera 141 and the second camera 151, lighting information, and position information of the traffic light.

B information contains the image data of the first image and the second image picked up by the first camera 141 and the second camera 151, the lighting information, and the position information of the traffic light.

When not receiving the vehicle numbers (ST330: NO), the processing device 7 performs image processing A (ST303).

The image processing A is processing same as ST303 of the first example embodiment.

Next, the processing device 7 detects the traffic abnormality through the image processing (ST304).

When no traffic abnormality is detected (ST304: NO), the processing device 7 starts image processing on a p+1-th frame (to ST310).

When the traffic abnormality is detected (ST304: YES), the processing device 7 captures vehicle numbers (ST335).

The target vehicle numbers are the vehicle number of the at-fault vehicle and the vehicle number(s) of the surrounding vehicle(s), including a damaged vehicle, that is present around the at-fault vehicle.

When it is difficult to capture the vehicle number of the at-fault party, the processing device 7 may capture only the vehicle number of the surrounding vehicle. A secondary disaster induced by the at-fault vehicle is also conceivable, so that, in the present example embodiment, information on the site in which the traffic abnormality occurs as well as on vehicles around the site is wholly ascertained before a secondary disaster occurs.

Next, the processing device 7 transmits, to the host system 2, the accident vehicle number of the at-fault vehicle, and the surrounding vehicle number of the surrounding vehicle, including the damaged vehicle, that is present around the at-fault vehicle (ST336).

Subsequently, the processing device 7 performs processing same as that of the first example embodiment (ST305 to ST311).

### (Operation and Effect)

According to the present example embodiment, the traffic status monitoring system 101 enables detection of traffic abnormalities by the processing device 7 performing the image processing on two images of the first image and the second image.

Furthermore, the accident vehicle number of the at-fault vehicle that is a trigger for the traffic abnormality, and the surrounding vehicle number(s) of the surrounding vehicle(s), including the damaged vehicle, that is present around the at-fault vehicle, are notified to the traffic lights around the site in which the traffic abnormality occurs, and are thereby simultaneously monitored. Use of integrated information allows the location and behavior of the at-fault vehicle to be ascertained successively in chronological order from the occurrence of the accident. This makes it also possible to detect an event of the second traffic abnormality, following the traffic abnormality, caused by the at-fault vehicle, or an event of another traffic abnormality induced by the traffic abnormality caused by the at-fault vehicle.

The traffic status monitoring system 101 according to the present disclosure therefore easily detects traffic abnormalities.

Furthermore, according to one aspect of the present disclosure, when the processing device 7 detects occurrence of a traffic abnormality, it is easy to notify a surrounding vehicle and an apparatus, such as a smartphone of a passerby, and another device, that the traffic accident occurs, as well as easy to guide a detour, from the host system 2. After the traffic abnormality is detected by the processing device 7, the host system 2 determines, based on gathered integrated information, whether calling attention is required for other apparatuses present near an intersection in which the traffic abnormality occurs. When the host system 2 determines a scale of a disaster due to the traffic abnormality and determines that an influence will be exerted on a surrounding vehicle and a passerby, the host system 2 notifies electronic apparatuses of the surrounding vehicle and the passerby that the traffic abnormality occurs nearby. Examples of the electronic apparatus include a dashboard camera, a car navigation system, and a smartphone. In the event that it is determined that a damage caused by the traffic abnormality is serious and passage of vehicles and people is difficult, a detour is guided.

### Third Example Embodiment

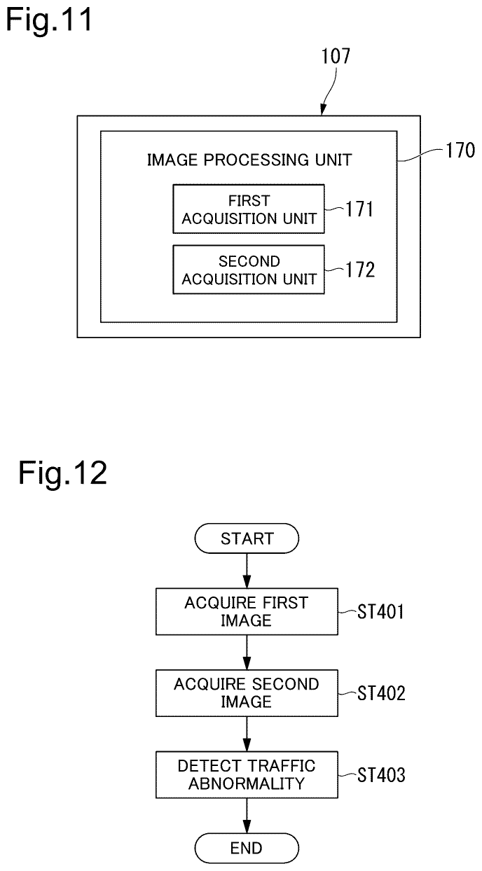

Hereinafter, an example embodiment with a minimum configuration of a processing device according to the present disclosure serving as a third example embodiment, will be described with reference to FIG. 11.

### (Configuration)

A processing device 107 includes a first acquisition unit 171 that acquires a first image picked up by a first camera of a first traffic light, the first traffic light including the first camera that picks up the first image containing at least one of a crosswalk and an intersection, and a first communication device, a second acquisition unit 172 that acquires a second image transmitted by a second communication device of a second traffic light, the second traffic light including a second camera that picks up the second image containing at least one of the crosswalk and the intersection, and the second communication device that transmits the second image to the first communication device, and an image processing unit 170 that detects, based on the first image and the second image, a traffic abnormality occurring in at least one of the crosswalk and the intersection.

### (Operation and Effect)

According to the present example embodiment, the processing device can detect a traffic abnormality by performing image processing on two images of the first image and the second image.

It is therefore easy to detect traffic abnormalities.

### Fourth Example Embodiment

Hereinafter, an example embodiment of a processing method, with a minimum configuration, according to the present disclosure serving as a fourth example embodiment, will be described with reference to FIG. 12.

The processing method in the present example embodiment is performed according to a flow illustrated in FIG. 12.

The processing method includes a step (ST401) of acquiring a first image picked up by a first camera of a first traffic light, the first traffic light including the first camera that picks up the first image containing at least one of a crosswalk and an intersection, and a first communication device, a step (ST402) of acquiring a second image transmitted by a second communication device of a second traffic light, the second traffic light including a second camera that picks up the second image containing at least one of the crosswalk and the intersection, and the second communication device that transmits the second image to the first communication device, and a step (ST403) of detecting, based on the first image and the second image, a traffic abnormality occurring in at least one of the crosswalk and the intersection.

### (Operation and Effect)

According to the processing method of the present example embodiment, the processing method allows detection of a traffic abnormality by acquiring two images of the first image and the second image and performing image processing.

The two images are acquired, whereby, in the present example embodiment, it is possible to avoid a situation in which a traffic abnormality cannot be detected when one camera cannot pick up an image containing the traffic abnormality.

The processing method according to the present disclosure therefore easily detects traffic abnormalities.

While the example embodiments of the present disclosure have been shown and described, the example embodiments are illustrated as examples and are not intended to limit the scope of the disclosure. The example embodiments can be implemented in various other forms, and various omissions, substitutions, and changes can be made without departing from the gist of the present disclosure. The example embodiments and modifications thereof are included in the scope and gist of the present disclosure, and are included in the scopes of the present disclosure and its equivalents.

### INDUSTRIAL APPLICABILITY

According to the aspects described above, it is easy to detect traffic abnormalities.

### REFERENCE SIGNS LIST

1 traffic status monitoring system
2 host system
3 in-vehicle device
31 camera
32 communication device
33 GPS
34 recording device
4 first traffic light
41 first camera
42 first communication device
5 second traffic light
51 second camera
52 second communication device
6 traffic light controller
7 processing device
71 image processing unit
711 first acquisition unit
712 second acquisition unit
713 recognition unit
72 communication processing unit
721 notification unit
73 recording device
101 traffic status monitoring system
103A at-fault vehicle
103B damaged vehicle
104 first traffic light
141 first camera
105 second traffic light
151 second camera
107 processing device
170 image processing unit
171 first acquisition unit
172 second acquisition unit

What is claimed is:

1. A processing device comprising:
at least one memory storing instructions; and
at least one processor configured to access the at least one memory and execute the instructions to:
acquire first image picked up by a first camera of a first traffic light, the first traffic light including the first camera that picks up the first image containing at least one of a crosswalk and an intersection, and a first communication device;
acquire second acquire a second image transmitted by a second communication device of a second traffic light, the second traffic light including a second camera that picks up the second image containing at least one of the crosswalk and the intersection, and the second communication device that transmits the second image to the first communication device; and
detect, based on the first image and the second image, a traffic abnormality occurring in at least one of the crosswalk and the intersection.

2. The processing device according to claim 1, wherein
the first image contains lighting information of the second traffic light, and
the second image contains lighting information of the first traffic light.

3. The processing device according to claim 1. wherein
the at least one processor is further configured to execute the instructions to:
cause the first communication device to transmit a request signal for requesting a surrounding situation image to a surrounding vehicle with respect to the first traffic light or the second traffic light.

4. The processing device according to claim 1, wherein
the at least one processor is further configured to execute the instructions to:
cause the first communication device to transmit, to a host system, integrated information containing the first image and the second image.

5. The processing device according to claim 4, wherein
the first traffic light further includes a traffic light controller, and
the integrated information contains lighting information of a traffic light acquired from the traffic light controller.

6. A traffic status monitoring system comprising:
the first traffic light including the processing device according to claim 1; and
the second traffic light.

7. The traffic status monitoring system according to claim 6, wherein
the first traffic light and the second traffic light are provided across the crosswalk or the intersection from each other.

8. The traffic status monitoring system according to claim 6, wherein
the at least one processor is further configured to execute the instructions to:
recognize, based on the first image and the second image, an accident vehicle number of a vehicle causing the traffic abnormality, and a surrounding vehicle number of a surrounding vehicle with respect to the vehicle; and
notify a surrounding traffic light adjacent to the first traffic light and the second traffic light of the accident vehicle number and the surrounding vehicle number.

9. A processing method comprising:
acquiring a first image picked up by a first camera of a first traffic light, the first traffic light including the first camera that picks up the first image containing at least one of a crosswalk and an intersection, and a first communication device;
acquiring a second image transmitted by a second communication device of a second traffic light, the second traffic light including a second camera that picks up the second image containing at least one of the crosswalk and the intersection, and the second communication device that transmits the second image to the first communication device; and
detecting, based on the first image and the second image, a traffic abnormality occurring in at least one of the crosswalk and the intersection.

10. A non-transitory recording medium recording a program for causing a computer to execute:
acquiring a first image picked up by a first camera of a first traffic light, the first traffic light including the first camera that picks up the first image containing at least one of a crosswalk and an intersection, and a first communication device;
acquiring a second image transmitted by a second communication device of a second traffic light, the second traffic light including a second camera that picks up the second image containing at least one of the crosswalk and the intersection, and the second communication device that transmits the second image to the first communication device; and
detecting, based on the first image and the second image, a traffic abnormality occurring in at least one of the crosswalk and the intersection.
